(19) United States
(12) Patent Application Publication
(10) Pub. No.: US 2006/0188608 A1
(43) Pub. Date: Aug. 24, 2006

(54) Nutritional supplement preparation with piperine

(75) Inventor: Gerhard Schmitt, Bensheim (DE)

Correspondence Address: AKERMAN SENTERFITT, 801 PENNSYLVANIA AVENUE N.W., SUITE 600, WASHINGTON, DC, 20004, US

(73) Assignee: PM-International AG, Luxembourg (LU)

(21) Appl. No.: 11/360,618

(22) Filed: Feb. 24, 2006

(30) Foreign Application Priority Data
Feb. 24, 2005 (EP) 05 004 035.1

(51) Int. Cl. A23L 1/30

(52) U.S. Cl. 426/72

(57) ABSTRACT

A nutritional supplement preparation is provided that includes minerals and trace elements such as vitamin D, calcium, magnesium, selenium, copper, zinc and chromium, as well as at least one catalyst and/or active ingredient, preferably in powder form, which increases and/or improves and/or accelerates the absorption of the minerals and/or trace elements.

### CROSS REFERENCE TO RELATED APPLICATIONS

This application claims priority to European Patent Application No. 05 004 035.1, filed Feb. 24, 2005, the entire contents of which are herein incorporated by reference.

### BACKGROUND OF THE INVENTION

1. Field of the Invention

The invention relates to nutritional supplement preparation containing minerals and trace elements (active ingredients) including vitamin D, calcium, magnesium, selenium, copper, zinc and chromium.

Magnesium influences conduction processes in the central and peripheral nervous system. Selenium is an anti-oxidative protective substance and is a building block in many enzyme systems. Chromium supports the glucose tolerance factor and therewith increases the response behavior to insulin. Chromium consequently fulfills an important function in sugar metabolism.

2. Description of the Related Art

A disadvantage with known nutritional supplement preparations is how long it takes for the minerals and trace elements to be absorbed (assimilated) after intake. Furthermore, minerals and trace elements contained together may mutually interfere with one another due to insufficient harmonization. For example, the absorption channels for a mineral or a trace element can be occupied by one or more other minerals or trace elements. The transport of individual active ingredients to the site of action can also be impeded by other active ingredients.

In addition, several active ingredients may not be compatible with one another. For example, calcium and magnesium mutually interfere with each other if their relative proportion and/or their molecular integration are not correct. Incorrect relative proportions and/or molecular integration can, for example, lead to complex formation.

### SUMMARY OF INVENTION

The present invention provides a nutritional supplement preparation with improved absorption properties for minerals and trace elements. Furthermore, the various minerals and trace elements are brought into harmony with one another so that they do not disturb one another in their absorption and in their transport to the sites of activity.

The present invention provides a nutritional supplement preparation containing the minerals and trace elements including vitamin D, calcium, magnesium, selenium, copper, zinc, and chromium, wherein the preparation has at least one catalyst and/or active substance, preferably in powder form, which increases and/or improves and/or accelerates the absorption of minerals and/or trace element. Advantageous refinements become apparent from the various embodiments.

In accordance with the above, the nutritional supplement preparation contains at least one catalyst and/or active agent (also designated as REC-Resorption-Enhancing Catalyst) in addition to the minerals and trace elements that include vitamin D, calcium, magnesium, selenium, copper, zinc and chromium, preferably in powder form, which increases and/or improves and/or accelerates the absorption of the minerals and/or trace elements.

The present invention provides improved absorption properties (including improved transport of the active ingredients to their site of action) of the nutritional supplement preparation. In this way, the minerals and/or trace elements are absorbed more rapidly into the body and can unfold their actions with less of a time interval from intake. The catalyst and/or active ingredient can also improve the effectiveness of the minerals and/or trace elements in the body. According to various embodiments, the nutritional supplement preparation counteracts osteoporosis and hyperacidity.

### DETAILED DESCRIPTION OF THE INVENTION

After an advantageous refinement, the catalyst and/or active ingredient includes a black pepper extract or it consists of black pepper extract. According to one embodiment, an effective catalyst and/or active ingredient may be extracted from black pepper (Piper nigrum).

In accordance with a preferred embodiment, the catalyst and/or active substance includes piperine (1-piperoylpiperidine C₁₇H₁₉NO₃ is a chemical variant), especially effective as an alkaloid, or it consists of it. A piperine, which is effective as a catalyst and/or active ingredient, can be obtained on the basis of pepper (Piper nigrum) as an initial substance.

According to one embodiment of the invention, it is advantageous if the proportion of piperine in the catalyst and/or the active ingredient lies in the range of 90 to 100 percent, especially in the range of 92 to 100 percent, preferably at least at 95 percent.

According to one embodiment, the catalyst and/or active substance remains substantially completely or at least as far as possible in its molecular structure as it exists in the black pepper. Moreover, in a preferred embodiment, the black pepper is a substance extracted from the plant black pepper rather than a synthetic chemical product. A special grinding may provide (at least to the greatest extent possible) the maintenance of the natural molecular structure.

According to some embodiments, it has proven to be particularly advantageous if the nutritional supplement preparation contains magnesium carbonate hydroxide. The use of magnesium carbonate hydroxide leads to an improved capacity to absorb magnesium, as well as to an increase in its effectiveness. However, many of the magnesium compounds offered on the market are generally hard to absorb. Previously, the use of magnesium carbonate was typical.

More appropriately, the nutritional supplement preparation contains according to the execution variant beta-carotene (provitamin A) and/or potassium and/or sodium and/or iron.

Iron is an additive that, among other things, has proven advantageous with strong hyperacidity. Especially high performance athletes and women should therefore use a nutritional supplement preparation with an iron component in order to assure the synthesis of hemoglobin.

A preferred refinement of the nutritional supplement preparation provides that the potassium component in the preparation lies between 0.15 and 35% by weight, preferably between 0.5 and 10% by weight, especially at 0.8% by weight, and/or that the calcium component in the preparation lies between 1.6 and 17% by weight, preferably between 2.5 and 10% by weight, especially at 4.5% by weight, and/or that the magnesium component lies between 0.8 and 5.0% by weight, preferably between 2 and 3% by weight, especially at 2.2% by weight, and/or that the zinc component in the preparation lies between 0.015 and 0.2% by weight, preferably between 0.05 and 0.1% by weight, especially at 0.08% by weight, and/or that the copper component in the preparation lies between 0.0015 and 0.017% by weight, preferably between 0.005 and 0.015% by weight, especially at 0.011% by weight, and/or that the chromium component in the preparation lies between 0.00015 and 0.0017%, preferably between 0.0002 and 0.00008% by weight, especially at 0.00028%, and/or that the selenium component in the preparation lies between 0.00015 and 0.0012% by weight, preferably between 0.0002 and 0.0006% by weight, especially at 0.00028% by weight, and/or that the iron component in the preparation lies at almost 0% by weight, or between 0.015 and 0.09% by weight, preferably between 0.03 and 0.09% by weight, especially at 0.08% by weight, and/or that the vitamin D component in the preparation lies between 0.00001 and 0.00008% by weight, preferably between 0.00002 and 0.00006% by weight, especially at 0.00004% by weight, and/or that the proportion in catalysts and/or active substances for improving absorption, especially the piperine component in the preparation lies between 0.15 and 1.7% by weight, preferably between 0.4 and 1.2% by weight, especially at 0.8% by weight.

Appropriate and preferred embodiments provide that the nutritional supplement preparation exists in a powder form. and/or is formed and designed for manufacture as an aqueous solution and/or formed and designed for manufacture of a beverage, especially a mineral based beverage. The preparation is especially simple, flexible and quick to take as a beverage, owing to which a rapid action is assured. A beverage also makes possible a problem-free and comfortable regular use without which the desired effects cannot as a rule be attained in humans.

Furthermore, a nutritional supplement preparation set has proven appropriate that includes as a basic substance a first nutritional supplement preparation according to the invention which contains no iron, and contains a second nutritional supplement preparation according to the invention which contains iron as an additive. The basic substance and/or additive can moreover be suited for individual use. In particular, the basic substance and additive can be mixed in any desired proportion to set a desired iron proportion. The significance of iron for specified human groups, especially athletes and/or women, is explained above. The nutritional supplement preparation set makes it possible for the respective user to adjust the iron proportion corresponding to his/her individual requirements by corresponding mixing of the basic substance and additive to produce an optimally composed preparation.

The characteristic values of an embodiment of the nutritional preparation of the invention will be presented below.

Proceeding from a nutritional supplement preparation portion of 6 g (grams), which corresponds to the daily amount to be taken, the following table provides typical amount values of the individual minerals or trace elements within this proportion. That means that the daily portion of 6 g contains 50 mg (milligrams) of potassium, 270 mg of calcium, etc. Additional unit used: μg (micrograms). Furthermore, the limits within which the respective substance can be varied are indicated. Additional substances are contained in addition to the indicated substances that, for example, serve the aroma and/or the solubility of the nutritional supplement preparation. In this way, good solubility and acceptable taste of the nutritional supplement preparation is attained.

| | Amount in | | |
|---|---|---|---|
| | a 6 gram | | |
| Mineral or trace element | portion | | Limiting value |
| Potassium | 50 | mg | 10 mg-2,000 mg |
| Calcium | 270 | mg | 100 mg-1,000 mg |
| Magnesium | 134 | mg | 50 mg-300 mg |
| Zinc | 5 | mg | 1 mg-11 mg |
| Copper | 670 | μg | 100 μg-1 mg |
| Chromium | 17 | μg | 10 μg-100 μg |
| Selenium | 17 | μg | 10 μg-70 μg |
| Iron | 5 | mg | 1 mg-5 mg |
| Vitamin D | 2.5 | μg | 1 μg-5 μg |

Furthermore the amount of piperine per 6 gram portion can typically lie from 0.1 mg to 10 mg, preferably from 0.3 mg to 2 mg, especially at 0.5 mg.

In a nutritional supplement preparation set, the basic substance corresponds to the above composition except for the iron value, which lies at 0 grams. In contrast the additive corresponds to the above composition including the iron value. The user can then adjust the individually desired iron value by appropriate mixture of basic substance and additive.

While the preferred forms of the invention have been disclosed, it will be apparent to those skilled in the art that various changes and modifications may be made that will achieve some of the advantages of the invention without departing from the spirit and scope of the invention. It will be apparent to those reasonably skilled in the art that other components performing the same function may be suitably substituted. Therefore, the scope of the invention is to be determined solely by the appended claims.

I claim:

1. A method for preparing a nutritional supplement containing minerals and trace elements including vitamin D, calcium, magnesium, selenium, copper, zinc, and chromium, wherein the method comprises:
providing a catalyst, an active substance, or a combination of the catalyst and the active substance that accelerate absorption of the minerals or the trace element.

2. The method according to claim 1, wherein the catalyst, the active substance, or the combination of the catalyst and the active substance are in powder form.

3. The method according to claim 1, wherein the catalyst, the active substance, or the combination of the catalyst and the active substance include a black pepper extract.

4. The method according to claim 1, wherein the catalyst, the active substance, or the combination of the catalyst and the active substance include a piperine (chemical designation 1-piperoylpiperidine C₁₇H₁₉NO₃), whereby the piperine is preferably extracted from black pepper.

5. The method according to claim 4, wherein the piperine is an alkaloid.

6. The method according to claim 4, wherein the piperine component is present in the catalyst or active substance in a range from 90% by weight to 100% by weight.

7. The method according to claim 6, wherein the piperine component is present in the catalyst or active substance in a range from 92 to 100% by weight.

8. The method according to claim 6, wherein the piperine component is present in the catalyst or active substance at least 95% by weight.

9. The method according to claim 3, wherein the catalyst, the active substance, or the combination of the catalyst and the active substance remain substantially in a molecular structure as present in the black pepper.

10. The method according to claim 1, further comprising providing magnesium carbonate hydroxide.

11. The method according to claim 1, further comprising providing beta carotene (provitamin A), potassium, sodium, iron, or any combination thereof.

12. The method according to claim 11, further comprising:
providing the potassium in a concentration that lies between 0.15 and 35% by weight, between 0.5 and 10% by weight, or at 8% by weight;
providing the calcium in a concentration that lies between 1.6 and 17% by weight, between 2.5 and 10% by weight, or at 4.5% by weight;
providing the magnesium in a concentration that lies between 0.8 and 5.0% by weight, between 2 and 3% by weight, or at 2.2% by weight;
providing the zinc in a concentration that lies between 0.015 and 0.2% by weight, between 0.05 and 0.1% by weight, or at 0.08% by weight;
providing the copper in a concentration that lies between 0.0015 and 0.017% by weight, between 0.005 and 0.015% by weight, or at 0.011% by weight;
providing the chromium in a concentration that lies between 0.00015 and 0.0017%, between 0.0002 and 0.00008% by weight, or at 0.00028% by weight;
providing the selenium in a concentration that lies between 0.00015 and 0.0012% by weight, between 0.0002 and 0.0006% by weight, or at 0.00028% by weight;
providing the iron in a concentration that lies at 0% by weight, between 0.015 and 0.09% by weight, between 0.03 and 0.09% by weight, or 0.08% by weight;
providing the vitamin D in a concentration that lies between 0.00001 and 0.00008% by weight, between 0.00002 and 0.00006% by weight, or at 0.00004% by weight; and
providing the piperine in a concentration that lies between 0.0015 and 0.17% by weight, between 0.005 and 0.034% by weight, or at 0.008% by weight.

13. The method according to claim 1, wherein the catalyst, the active substance, or the combination of the catalyst and the active substance is in a power form and is constructed and determined for manufacture of an aqueous solution, a beverage, or a mineral based beverage.

14. The method according to claim 1, further comprising a basic substance having a first nutritional supplement that includes no iron, whereby the basic substance is suited for independent use.

15. The method according to claim 14, further comprising a substance having a second nutritional supplement that includes iron, whereby the basic substance and any additives are suited for independent use, or whereby the basic substance and any additives are mixable for adjusting a proportion of the iron.
